(19) United States
(12) Patent Application Publication
(10) Pub. No.: US 2006/0265499 A1
(43) Pub. Date: Nov. 23, 2006

(54) Service Allocation Mechanism

(76) Inventors: Daniel A. Menasce, Cabin John, MD (US); Hassan Gomaa, Charlottesville, VA (US); Honglei Ruan, Fairfax, VA (US)

Correspondence Address: GEORGE MASON UNIVERSITY;OFFICE OF TECHNOLOGY TRANSFER, MSN 5G5, 4400 UNIVERSITY DRIVE, FAIRFAX, VA, 22030, US

(21) Appl. No.: 11/419,226

(22) Filed: May 19, 2006

Related U.S. Application Data
(60) Provisional application No. 60/683,340, filed on May 23, 2005.

(51) Int. Cl. G06F 15/173

(52) U.S. Cl. 709/225

(57) ABSTRACT

A system and method for allocating services is disclosed. A broker records a capability, for providing a service, and a demanded amount of resources for providing the services from at least one provider. A consumer requests a desired quality of service from the broker. The broker, using the demanded amount of resources and recorded capability, determines if the desired quality of service can be provided. If the broker can satisfy the request, the broker issues a certificate to the consumer, and the consumer provides the certificate directly to the provider to authorize provision of the service at the desired quality of service. If not, the broker generates a counter-offered quality of service that corresponds to the available amount for resources for accomplishing the service. In response, the consumer either rejects the counter-offered quality of service or accepts the counter-offer and receives a certificate for the counter-offered quality of service.

### CROSS-REFERENCES TO RELATED APPLICATIONS

This application claims priority from provisional patent application No. 60/683,340 which was filed May 23, 2005, the contents of which are expressly incorporated herein.

### STATEMENT REGARDING FEDERALLY FUNDED SPONSORED RESEARCH OR DEVELOPMENT

The U.S. Government has a paid-up license in this invention and the right in limited circumstances to require the patent owner to license others on reasonable terms as provided for by the terms of Grant No. 523015 awarded by the National Science Foundation.

### BRIEF DESCRIPTION OF THE DRAWINGS

In the accompanying drawings:

FIG. 1 shows an overview of a service allocation mechanism according to an embodiment of the present invention;

FIG. 2 illustrates the service allocation mechanism shown in FIG. 1 in greater detail;

FIG. 3 is a flowchart depicting a method of operating the service allocation mechanism according to one embodiment of the present invention from the perspective of a service broker;

FIG. 4 is a flowchart depicting a method of operating the service allocation mechanism according to one embodiment of the present invention from the perspective of a service provider; and,

FIG. 5 is a flowchart depicting a method of operating the service allocation mechanism according to one embodiment of the present invention from the perspective of a consumer.

### DETAILED DESCRIPTION OF THE EMBODIMENTS

In the following detailed description, the term “message” generally refers to a signal representing a digital message. The term “mechanism” can be used herein to represent hardware, software or any combination thereof. The mechanisms described herein can be implemented on standard, general-purpose computers, or they can be implemented as specialized devices. The mechanisms and servers may operate electronically, optically or in any other fashion.

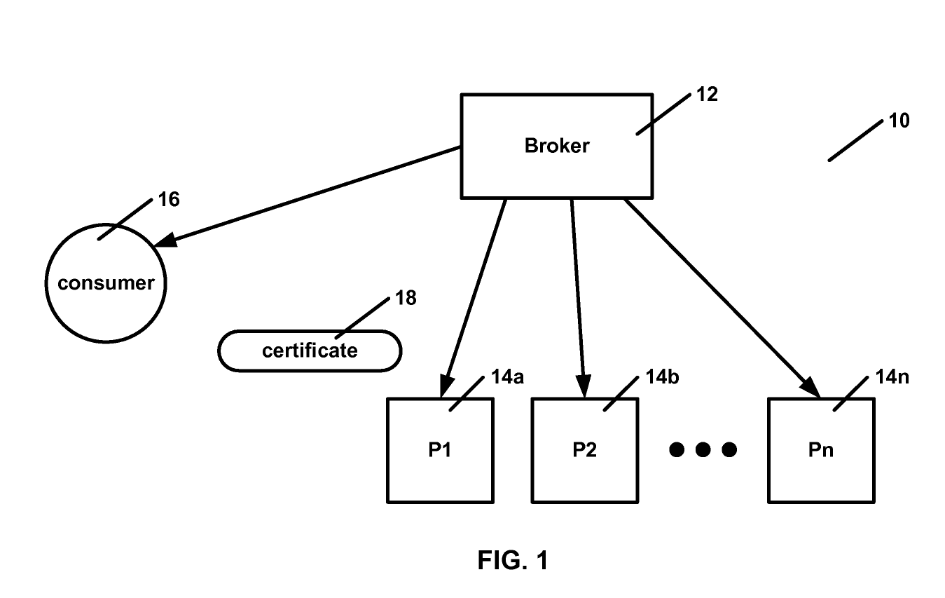

Performance requirements may require that mechanisms for providing services using scarce resources be able to adapt and reconfigure themselves. An embodiment of the present invention shown in FIG. 1 provides a mechanism configured to provide services at a desired quality in a dynamic fashion according to the needs of the consumer and to also reconfigure itself according to the amount of available resources for allocation of services to the consumer. One of ordinary skill would also recognize that an embodiment of the present invention may also be adapted to reconfigure itself for security or availability reasons.

In one embodiment of the present invention, the service to be allocated can have a Quality of Service, or QoS. Some of the different aspects of QoS include response time, concurrency (the number of requests for a service that a provider can process at the same time) and throughput (the total number of services provided over a unit amount of time). Many providers provide similar services with common functionality, but with different QoS and cost according to the resources available for providing the service at the desired QoS. It may be necessary to provide a negotiation mechanism between consumers (or applications) and providers to reach mutually agreed-upon QoS goals, in order for providers to guarantee QoS agreements at runtime.

Consider, as an example, that several stockbrokers provide stock quote services with different response times (and different corresponding costs). A consumer can choose a stockbroker that satisfies its response time requirements within its budget by negotiating with each stockbroker. If a stockbroker cannot satisfy the response time requirements of the consumer, the stockbroker can make a counter-offer with lower cost and/or higher response times. Alternatively, the consumer can turn to another broker to have its needs satisfied. Once a stockbroker has been selected, the stockbroker must guarantee the negotiated response time at runtime.

Another example can be that of an online travel agent that uses airline reservation, hotel reservation, car rental reservation, and payment processing services provided by a multitude of third-party service providers. The response time and throughput characteristics of the travel agency may depend on the QoS of these external providers. Therefore, QoS negotiation and adherence to negotiated QoS goals assists in the adequate performance of the travel agency.

Referring again to FIG. 1, an overview of such a mechanism that may allocate resources to allow providers to provide a certain QoS for a consumer, according to one embodiment of the present invention, can be described and can be generally designated by reference character 10 in FIG. 1. As shown, the mechanism according to one embodiment of the present invention includes a broker component 12 and at least one provider component, of which provider components 14a, 14b through 14n are examples thereof. Providers 14a-14n may register a demanded amount of resource, or the amount of resources that may be required for providing services, and a description of the provider capability for providing a service, with broker 12 before the broker may act on their behalf. Stated differently, provider 14 may inform broker 12 about its resource descriptions for providing the service and the demanded amount of each resource at each of the devices of the mechanism platform where the provider runs. Providers 14a through 14n may each register with broker 12 as stated above. The broker accepts the registration; thus, broker 12 has negotiation and resource allocation capabilities that have been granted by the providers 14.

In mechanism 10, a consumer 16 may find a broker 12 and then communicate with the broker 12. More specifically, the consumer 16 may enter into a negotiation with broker 12 by requesting a desired service at a desired quality, or QoS, from broker 12. Broker 12 may receive the request, and in response, select a provider 14a-14n that, after consideration of the needed amount of resources to execute the requested service, the desired QoS, and the already committed resources to previous requests, has a sufficient amount of resources for providing the service at the desired quality for the consumer. Or, if the desired QoS cannot be satisfied by any of providers 14a-14n, the broker 12 can either generate a counter-offered QoS or reject the request from consumer 16.

In sum, the consumer's service request may be accepted, rejected, or counter-offers (for degraded QoS) may be made to the consumer 16, who can accept or reject the counter-offer. If a negotiation is successful, the broker 12 may issue a secure confirmation token, or certificate 18, to the consumer 16. The broker 12 may then update its records to reflect the new amount of resource that can be available for allocation.

Consumer 16 may use confirmation certificate 18 to request service executions from the provider. To do this, the consumer 16 may receive the confirmation certificate 18 from the broker 12 and forward the confirmation certificate 18 directly to the provider 14, together with the request for service execution from the provider 14. The provider 14 may perform the requested service for the consumer 16 without having to conduct time-consuming negotiations on its own behalf, because the certificate can be formatted so that the provider knows that allocation resources to the particular consumer has been authorized by the broker. The format of the request, and confirmation certificate will be described more fully hereinafter.

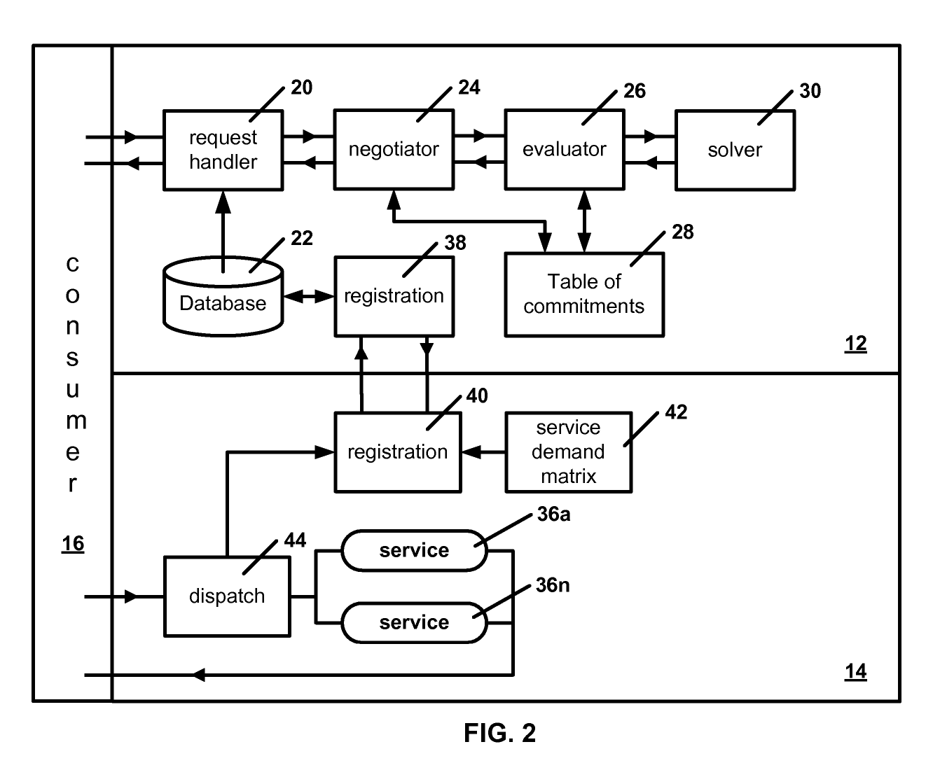

Referring now to FIG. 2, an embodiment of the structure and cooperation of the structure of the broker and provider are shown in greater detail. As shown in FIG. 2, broker 12 comprises a request handler 20 that may be in direct two-way communication with a database 22 and with negotiator mechanism 24. Negotiator mechanism 24 may be further in two-way communication with request evaluator mechanism 26, and with a resource Table of Commitments (ToC) 28 according to an embodiment of the invention. The broker may maintain the ToC 28 of demanded amounts of resources that have already been committed by provider 14 for providing a QoS to other consumers, so that broker 12 can dynamically evaluate if an incoming service request can be granted, rejected, or if a counter-offer is feasible.

Request handler 20 may receive a QoS request p for a desired service at a desired quality from consumer 16. The request p may be in the following format: ρ=(SessionID, providerID, ServiceID, N_{req}, RMAX, XMIN, ExpireDateTime, Kₚᵤ^{C}) where SessionID uniquely identifies a session generated by consumer 16. ProviderID may identify the provider 14 with whom the session can be established, ServiceID may identify the service that is being requested by the session and N_{req} may be the requested concurrency level (i.e., the maximum number of requests concurrently executing the requested service in the session). RMAX may be the maximum average request response time required for the session, XMIN may be the minimum throughput required for the session, ExpireDateTime may be the expiration date and time of the session and Kₚᵤ^{C} may be the public key of the consumer 16. The public key may be used by a provider for authentication purposes. As those skilled in the art would appreciate, Kₚᵤ^{C} may be delivered as part of a digital certificate signed by a trusted certificate authority. Note that other formats for the service request could be used.

Three types of messages may be received from the consumer by the QoS requests handler. The first type of message may be the aforementioned QoS service request. This message may be a request to start a session with certain service requests (according to one embodiment of the invention, for QoS requests). This request may be accepted or rejected. Or, a counter-offered QoS with a different concurrency level, larger response time, or smaller throughput may be generated as a result of the request. The decision about accepting, rejecting, or providing a counter-offered QoS may be taken by the broker 12, on behalf of a provider 14. When broker 12 commits to a QoS request p on behalf of a provider 14, the QoS Broker may place the information about the request into a ToC 28, which holds all committed and unexpired sessions.

When broker 12 commits to a QoS request ρ on behalf of a provider 14, broker 12 may also generate a confirmation certificate 18. The confirmation certificate 18 may be signed by broker 12 and issued to consumer 16. The confirmation message 18 includes information on providerID, CommitmentID, SessionID, ServiceID, N_{offer}, ExpireDateTime, and Kₚᵤ^{C}. Service providerID may consist of the IP address of the selected provider and the port number on which the provider may be listening; CommitmentID may be the index in the TOC of the committed session; N_{offer} may be the maximum concurrency level offered by the provider in order to provide a certain response time and throughput; SessionID, resourceID, ExpireDateTime, and Kₚᵤ^{C} are as defined as above.

The second type of message that may be received by the request handler is an accept counter-offer message. This occurs when the requested QoS requires greater amounts of resources than the available amount of resources and the broker 12 may not accepts. Instead, broker 12 may notify consumer 16 that the requested QoS may not be provided. Broker 12 may generate a counter-offered QoS, which may be equal to the highest QoS that can be provided with available amount of remaining resources available for allocation. The counter-offered QoS may be sent to consumer 16 along with a confirmation certificate 18 that describes the counter-offered QoS. The request, modified per the counter-offer, may be placed in ToC 28 and flagged as “temporary” to give consumer 16 a chance to accept or reject the counter-offer. Counter-offers may expire after a predetermined time period. If the acceptance arrives too late, the corresponding temporary commitment may be deleted from the ToC and the requester may be notified.

If the consumer 16 accepts the counter-offered QoS, the consumer 16 may send an accept counter-offer message to broker 12. This message may be used to indicate to broker 12 that a counter-offered QoS can be accepted. In this case, the temporary commitment, if not yet expired, may be made permanent.

Finally, a third type of message that may be received by the request handler 20 can be a reject counter-offer message. This message may indicate that a counter-offered QoS was rejected. In this case, the temporary commitment may be deleted from the ToC. In sum, a first type of message received by request handler may be a QoS request from consumer 16, a second type may be a timely acceptance of a counter-offered QoS and a third type of message may be a rejection of a counter-offered QoS by consumer 16.

After receiving request p, the request handler 20 may pass the request p to resource negotiator 24, which may further pass the request to ToC 28 and to the request evaluator mechanism 26. Resource evaluator mechanism 26 may be in communication with the ToC 28 and with the performance model solver 30. Model solver mechanism 30 may cooperate with the resource request evaluator 26 to further determine whether the request for the service at the desired quality of service from consumer 16 can be met. The following notation may be used to describe how this is accomplished (although other notation could be used). The service being evaluated in one embodiment of the invention may be quality of service, QoS:

ρ: QoS request being evaluated.

ω: set of all committed QoS requests.

\overline{x}: indicates a violation of a QoS goal associated to x, where x may be either a QoS goal, a QoS request, or the set of already committed requests. \hat{x}: indicates a satisfaction of a QoS goal associated to x, where x may be a QoS goal, a QoS request, or the set of already committed requests.

argmax_{n{c}: the maximum value of N that makes condition c true.}

argminₙ{c}: the minimum value of N that makes condition c true.

X(n): throughput of the request being evaluated when the concurrency level for that request can be n. This throughput may be obtained by solving a performance model considering the already committed requests.

R(n): average response time of the request being evaluated when the concurrency level for that request can be n. This response time may be obtained by solving a performance model considering the already committed requests.

N: concurrency level for request being evaluated.

N_{req}: requested concurrency level for the request being evaluated.

N_{off}: offered concurrency level for the request being evaluated.

R_{off}: offered response time for the request being evaluated.

X_{off}: offered throughput for the request being evaluated.

For the embodiment wherein the provider resources are being allocated to accommodate different QoS requests for different consumers, QoS evaluation may be divided into seven parts as described below. The first case corresponds to the case when both ρ and ω are satisfied. In the second through fourth cases, none of the already committed requests are violated but one or two of the QoS goals (i.e., response time or throughput) of the request under evaluation are violated. The possible outcomes in these cases may be acceptance or a counter-offer. Finally, in cases five through seven, at least one of the already committed requests may be violated. The possible outcomes include rejections or counter-offers.

In the first case, the current request and all committed sessions may be accepted (\hat{ρ}ˆ\hat{ω}): Accept ρ.

In the second case, only the response time goal for the current request may be violated but all committed sessions are satisfied (\overline{R}ₘₐₓˆ\hat{ω}). A possible remedy may be found by decreasing the offered concurrency level. Note that this action may not negatively affect the already committed requests. More precisely,

if ∃ (1 ≦ N < N_{req}) | \hat{ρ}
then C_{off} (N_{off} = argmax_{N}{\hat{ρ}})
else C_{off} (N_{off} = argmin_{N}{\hat{X}ₘᵢₙ},R_{off} = R(N_{off}))

In the third case, only the throughput goal for the current request may be violated but all committed sessions may be okay (\overline{X}ₘᵢₙˆ\hat{ω}). A possible remedy may be found by increasing the offered concurrency level as long as it does not violate the already committed requests. More precisely,

if ∃ (N > N_{req}) | (\hat{ρ} [symbol] \hat{ω})
then Accept ρ with N_{off} = argmin_{N}{\hat{ρ} [symbol] \hat{ω}}
else C_{off} (N_{off} = argmax_{N}{\hat{R}ₘₐₓ [symbol] \hat{ω}},X_{off} = X(N_{off}))

In the fourth case, the response time and throughput goals for the current request may be violated but all committed sessions are okay (\overline{R}ₘₐₓˆ\overline{X}ₘᵢₙˆ\hat{ω}). In this case, one may try to to satisfy the response time goal of the current request by lowering the offered concurrency level. This action may not negatively affect the already committed requests. If it is not possible to satisfy the response time goal, an attempt may be made at satisfying the throughput goal of the current request without violating the already committed requests. If it is not possible to satisfy either the response time or the throughput goals of the current request, then a counter-offer that is based on the requested concurrency level could be sent. More precisely,

```
if ∃ (1 ≦ N < N_{req}) | \hat{R}ₘₐₓ
then C_{off} (N_{off} = arg max_{N}{\hat{R}ₘₐₓ},R_{off} = R(N_{off}),X_{off} = X(N_{off}))
else if ∃ (N > N_{req}) | (\hat{X}ₘᵢₙ [symbol] \hat{ω})
  then C_{off} (N_{off} = arg max_{N}{\hat{X}ₘᵢₙ [symbol] \hat{ω}},R_{off} = R(N_{off}),X_{off} = X(N_{off}))
  else C_{off} (R_{off} = R(N_{off}),X_{off} = X(N_{req}))
```

In the fifth case, the response time goal of the current request and at least one of the committed sessions may be violated (\overline{R}ₘₐₓˆ\overline{ω}). In order to attempt to solve the problem with the already committed requests, one has to decrease the concurrency level of the current request. If it is not possible to find such concurrency level greater than zero, then the current request could be rejected. Otherwise, a counter-offer could be sent. More precisely,

```
if ∃ (1 ≦ N < N_{req}) | (\hat{ρ} [symbol] \hat{ω})
then C_{off} (N_{off} = arg max_{N}{\hat{ρ} [symbol] \hat{ω}})
else if ∃ (1 ≦ N < N_{req}) | (\hat{ω} [symbol] \hat{X}ₘᵢₙ)
  then C_{off} (N_{off} = arg max_{N}{\hat{ω}},R_{off} = R(N_{off}))
  else if ∃ (1 ≦ N < N_{req}) | \hat{ω}
    then C_{off} (N_{off} = arg max_{N} {\hat{ω}},R_{off} = R(N_{off}),X_{off} = X(N_{off}))
else Reject ρ
```

In the sixth case, the throughput goal of the current request and at least one of the committed sessions may be violated (\overline{X}ₘᵢₙˆ\overline{ω}). In order to attempt to solve the problem with the already committed requests, the concurrency level of the current request may be decreased. If it is not possible to find such concurrency level greater than zero, then the current request should be rejected. Otherwise, a counter-offer should be sent. More precisely,

if ∃ (1 ≦ N < N_{req}) | \hat{ω}
then C_{off} (N_{off} = argmax_{N} {\hat{ω}},X_{off} = X(N_{off}))
else Reject ρ

In the last case, the response time and throughput goals for the current request may be violated and at least one of the committed sessions may be violated (\overline{X}ₘᵢₙˆ\overline{R}ₘₐₓˆ\overline{ω}). In order to attempt to solve the problem with the already committed requests, the concurrency level of the current request should be decreased. If it is not possible to find such concurrency level greater than zero, then the current request should be rejected. Otherwise, a counter-offer should be sent. More precisely,

if ∃ (1 ≦ N < N_{req}) | \hat{ω}
then C_{off} (N_{off} = argmax_{N}{\hat{ω}},R_{off} = R(N_{off}),X_{off} = X(N_{off}))
else Reject

The performance solver may help with the resource request evaluation by modeling the impact of each request on a particular provider that is already committed to allocating other amounts of resources to other consumers. The performance solver 30 may build a dynamic model each time that a QoS request for a particular provider is to be evaluated by evaluator 26. Since there may be several providers 14a-14n running on the same mechanism and further competing for its resources to provide their respective services, a new performance model has to be built and evaluated for each new service request ρ. One performance modeler that could be used according to one embodiment of the invention may be that described in D. A. Menasce, “Two-Level Iterative Queuing Modeling of Software Contention,” Proceedings 10^{th} IEEE Int. Symp. Modeling, Analysis and Simulation of Computer and Telecommunications Systems (MASCOTS '02), Oct. 11-16, 2002 Fort Worth Tex., the contents of which are hereby incorporated by reference in their entirety. According to this embodiment of the present invention, a mechanism that includes a combination of a software queuing network (SQN) and a hardware queuing network (HQN) may be used. Other performance models could also be used.

Referring again primarily to FIG. 2, the structure of the provider is reviewed is greater detail. Provider 14 includes a resource registration mechanism 40 that implements the interaction with the resource registration mechanism 38 of broker 12 for registering its service descriptions, or its capability for providing the service, as well as for a service demand matrix. Service demand matrix 42 holds the demanded resources for providing the service at each device on which it runs. A service dispatcher mechanism 44 may receive requests for services, of which services 36a-36n in FIG. 2 are representative, and send the requests to an available thread to execute the service 36a-36n at the desired QoS. The dispatcher 44 may also implement admission control within an accepted session. Dispatcher 44 may accomplish this by not accepting additional requests for a session if the number of concurrently executing requests for the session is equal to a predetermined concurrency level. The dispatcher may also perform the verification as to whether a request is legitimate by verifying the attached digital signature of the requester.

As shown in FIG. 1, a broker 12 may be shared by several providers 14a-14n. For embodiments of the present invention where there may be a plurality of providers 14a-14n, the broker 12 may maintain the aforesaid ToC 28 in which each entry corresponds to a provider 14 and a set of related commitments. Each commitment may consist of CommitmentID, SessionID, ServiceID, N_{offer}, RMAX, XMIN, and ExpireDateTime. ProviderID, SessionID, ServiceID, N_{offer}, and ExpireDateTime, which are as described before.

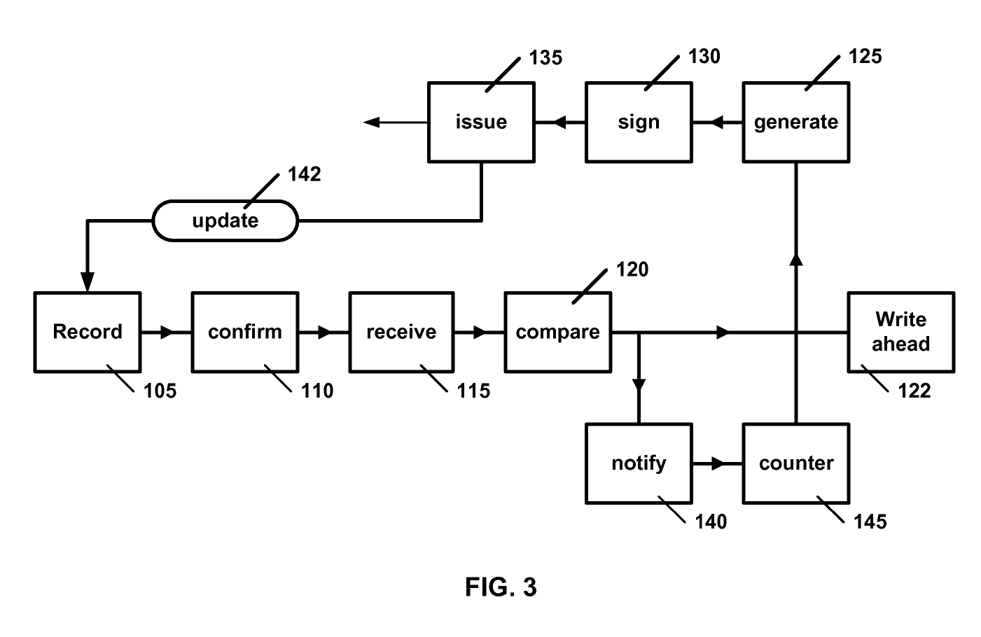

Referring now to FIG. 3, a method for allocating services according to an embodiment of the present invention is shown from the perspective of the broker 12. Initially, broker 12 may record at 105 the provider 14 service description and basic service demand matrices that have been registered by provider 14. The broker may confirm the registration with provider at 110 by sending its public key (Kₚᵤ^{QB}) to the provider. The broker may receive at 115 a QoS request ρ in the aforementioned format from a consumer. In response, the broker may determine at 120, with the evaluator 26 and solver 30 using the service demand matrix and the provider description as described above, whether the provider has the resources to provide the services at the desired QoS. If the broker determines that the QoS can be provided, the broker may generate at 125 the confirmation certificate 18, which may be formatted as (providerID, CommitmentID, SessionID, ServiceID, N_{offer}, ExpireDateTime, Kₚᵤ^{C}). The broker may sign at 130 the confirmation certificate with its private Kₚᵣ^{QB}. Next, the broker may issue at 135 the signed confirmation certificate 18 to consumer 16, and updates at 142 the ToC 28 with the new amount of resources that have been committed to provide services at a desired QoS.

In the case where more than one provider can be registered with the broker, the broker 12 may select a provider 14 that can satisfy the request. The broker may generate a confirmation certificate 18 that can uniquely identify the provider that can satisfy the given request. The consumer may receive the confirmation certificate and then forward the confirmation certificate directly to the applicable provider who can satisfy the request.

If the broker determines that none of the registered providers 14a-14n can provide the requested service at the desired QoS with the resources available, the broker 12 may notify at 140 the consumer 16 and generates at 145 a counter-offered QoS that can be provided with the maximum amount of resources available from any of the providers 14a-14n. If broker 12 receives acceptance of the counter-offered QoS from consumer 16 within a predetermined time as described above, broker may generate a confirmation certificate ρ according to the aforementioned format, but with the parameters of ρ changed according to the counter-offered QoS to be provided. The broker may sign at 130 the confirmation certificate with its private key Kₚᵣ^{QB} and issues at 135 the signed confirmation certificate 18 as described above.

According to another embodiment of the invention, the resource allocation mechanism may have increased fault-tolerance and performance. To do this, broker 12 may store identification data of each provider 14 in database 22. Also broker may write at 122 an entry in a write-ahead log (not shown) every time that broker generates at 125 and signs at 130 a confirmation certificate, or generates a counter-offered amount at 145. Also, broker may write an entry to the log when it receives an accept-counter-offer or an end-of-session message. Finally, the broker may write an entry to the log every time that a temporary commitment expires. The log may be used to rebuild the broker's ToC in case of a failure of the broker. This may be done in a straightforward manner known in the art by processing the write-ahead log backwards as done in database management mechanism failure recovery.

In yet another embodiment of the present invention, a single broker 12 may be replaced with a collection of brokers, as done in replicated Universal Description Discovery and Integration (UDDI) registries. For this embodiment, at any point in time only one broker should be responsible for brokering QoS requests for all the providers running on a given mechanism. Distributed election algorithms may be used to elect a new broker should the broker for a given set of providers fail. This may be possible if the state information (i.e., the ToC and resource registrations) of the failed broker can be replicated. A replication scheme should allow for load balancing techniques to be used to improve performance of the set of brokers.

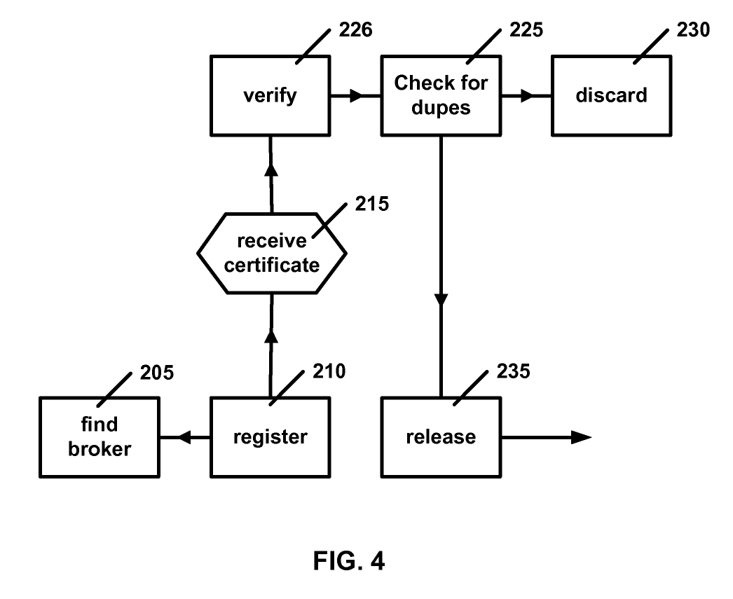

Another embodiment of the present invention according to the perspective of provider 14 is shown in FIG. 4. Initially, a provider may find at 205 a broker 12. Provider 14 may register a description of its ability to provide a service, given its resources, and a basic service demand matrix at 210 with the broker 12. To do this, the aforementioned provider registration mechanism 40 should interact with the broker registration mechanism 38.

Once broker 12 has obligated an amount of resources of provider 14 for accomplishing a desired service at a desired QoS, and issued a confirmation certificate to consumer 16, the provider may receive the confirmation certificate at 215 directly from consumer 16. Provider may then verify at 220 the confirmation certificate. To do this, the broker may use the broker signature, Kₚᵤ^{QB}, to ensure the confirmation certificate has not been modified and that it was indeed issued by the broker. This may be done because the provider received the broker's public key when it registered at 210 with the broker and when the broker confirmed the registration at 110. If the signature can be verified, N_{offer} and Kₚᵤ^{C} should be extracted from confirmation certificate 18. The provider may then verify, using Kₚᵤ^{C}, the signature of S_{C} [ServiceRequest], which is the service request from consumer 16.

In addition to verifying the confirmation certificate 18, provider 14 may also check at 225 whether the current request might be a duplicate of a previously received request. This may be done by keeping the latest request ID received from each session. Duplicate requests may be discarded at 230 to prevent replay attacks. The purpose of verifying and checking S_{C} [ServiceRequest] can be to prevent replay attacks, specifically, to prevent a third party from reusing the confirmation certificate. This goal may be achieved because every request in a session has a unique request ID.

After successful verification at 220, and checking at 225 for whether the confirmation certificate is a duplicate, if the request has not expired (by comparing the current time with ExpireDateTime extracted from the token), the provider may release the resource at 235 to provided the service at the desired QoS to the consumer 16 that requested the QoS and that presented the confirmation certificate from the broker to the provider.

Therefore, every service request from an authorized consumer 16 that includes a confirmation certificate issued at 135 by the broker 12 to the authorized consumer should have a different signature. Even though a third party may intercept a request, it should not be able to generate the same signature as the authorized consumer without knowing the private key (Kₚᵣ^{C}) of the consumer. Even though it may maliciously repeat sending the intercepted message to the provider, the provider may discard any duplicate message.

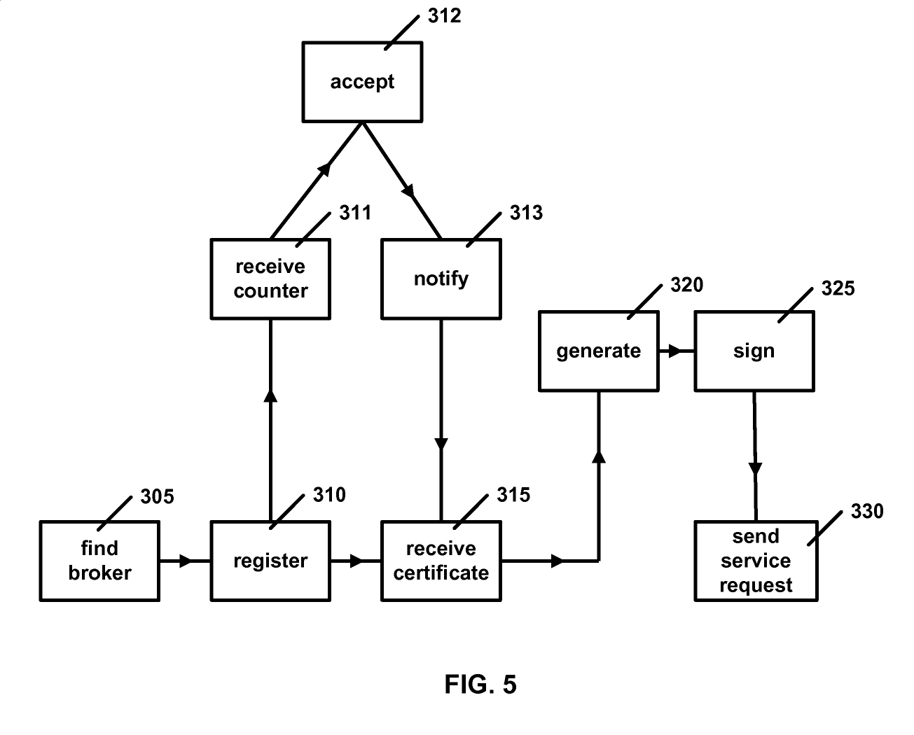

Referring now to FIG. 5, another embodiment of the present invention according to the perspective of consumer 16 is shown. Consumer 16 finds at 305 a broker 12, and may request at 310 a service at a requested QoS from the broker. In response to the request, the broker may determine if there is a provider that has sufficient amount of resources available to satisfy the request made at 310. If so, the broker may send a confirmation certificate in the format that is described above to consumer 16.

The consumer may receive at 315 the confirmation token, or certificate 18, for the desired QoS. Consumer 16 may generate at 320 a service request message to be sent to the provider and sign the message at 325. Finally, the consumer may then send at 330 the service request message directly to the provider identified by providerID. The service request message may have the format α=(Token, S_{QB} [Token], ServiceRequest, S_{C} [ServiceRequest]), where the Token may be composed of confirmation certificate 18, and ServiceRequest may be uniquely identified by a request ID in the session. In other words, a service request message may be composed of a token (such as confirmation certificate 18) that can be signed by the broker and a service request signed at 325 by the consumer.

In the case where the broker determines that the consumer's initial QoS request cannot be accommodated, the broker may generate a counter-offered QoS as described above and send it to the consumer. The consumer 16 may receive the counter-offered QoS at 311. The consumer may then determine if the counter-offered QoS is acceptable. If so, the consumer may accept at 312 the counter-offered QoS and notify at 313 the broker. The broker may generate a confirmation certificate that is representative of the counter-offered QoS. The consumer may receive the certificate for an amount equal to the counter-offered amount as described above, then generates 320, signs 325, and sends service request messages 330 to the provider 14, as described above.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. In fact, after reading the above description, it will be apparent to one skilled in the relevant art(s) how to implement the invention in alternative embodiments. Thus, the present invention should not be limited by any of the above-described exemplary embodiments. In particular, it should be noted that, for example purposes, the above explanation has focused on the example(s) of a Quality of Service broker. However, those experienced in the art will realize that multiple other embodiments can be used.

In addition, it should be understood that any figures, screen shots, tables, examples, etc. which highlight the functionality and advantages of the present invention, are presented for example purposes only. The architecture of the present invention can be sufficiently flexible and configurable, such that it may be utilized in ways other than that shown. For example, the steps listed in any flowchart may be re-ordered or only optionally used in some embodiments.

Further, the purpose of the Abstract of the Disclosure can be to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

Furthermore, it can be the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. §112, paragraph 6.

Thus, a mechanism and method allocating resources can be disclosed. One skilled in the art will appreciate that the present invention can be practiced by other than the described embodiments, which are presented for purposes of illustration and not limitation, and the present invention can be limited only by the claims that follow.

What is claimed is:

1. A method for allocating a resource for achieving a requested quality of service for a consumer comprising:
recording a demanded amount of the resource from at least one provider and a description of a capability of the provider for providing the service, the demanded amount being already committed for providing the service to other consumers;
confirming the recording of the demanded resource amount and the service description with the provider;
receiving a requested quality of service from the consumer;
using the demanded resource amount and the service description to determine if the provider can accomplish the requested quality of service; and
issuing a certificate to the consumer if the requested quality of service can be accomplished by the provider, the certificate authorizing the provider to dispense the resource to accomplish the service for the consumer at the desired quality of service.

2. The method of claim 1, further comprising updating the demanded amount after the certificate is issued.

3. The method of claim 1, further comprising:
if the requested quality of service cannot be accomplished by the provider:
notifying the consumer that the requested quality of service cannot be provided to the consumer;
generating a counter-offered quality of service; and
forwarding the counter-offered quality of service to the consumer for consideration.

4. The method of claim 3, further comprising updating the demanded resource amount according to the counter-offered quality of service when the counter-offered quality of service is accepted.

5. The method of claim 1, wherein the quality of service is response time.

6. The method of claim 1, wherein the quality of service is concurrency, concurrency being the number of requests for a resource that can be processed simultaneously.

7. The method of claim 1 wherein the quality of service is throughput, throughput being the number of requests for a resource that can be processed per unit time.

8. The method of claim 1 wherein;
a first provider has a first demanded resource amount, and a first service description;
a second provider has a second demanded resource amount and a second service description;
the requested quality of service can be accomplished by the first demanded resource amount and first service description; and,
the certificate that is issued to the consumer is forwarded to the first provider.

9. The method of claim 8 wherein the certificate identifies the provider that can provide the desired quality of service.

10. A method for a consumer to obtain a guaranteed quality of service from a provider comprising the steps of:
finding a broker having an available amount of resources allocated to the broker from the provider for providing the service;
requesting the guaranteed quality of service from the broker;
receiving a confirmation token from the broker when the guaranteed quality of service can be accomplished with the available resource amount; and
forwarding the commitment token to the provider, the provider releasing resource to provide the guaranteed quality of service to the consumer in response to the commitment token.

11. The method of claim 10 wherein the broker updates the available resource amount according to the resources released to provide the guaranteed quality of service to the user.

12. The method as recited in claim 10 wherein the guaranteed quality of service cannot be accomplished with the available amount and further comprising:
receiving a counter-offered quality of service from the broker;
deciding whether the counter-offered quality of service is acceptable; and,
accepting the confirmation token from the broker, the confirmation token being representative of the counter-offered quality of service.

13. The method of claim 10 where the quality of service is response time.

14. The method of claim 10 wherein the quality of service is concurrency, concurrency being the number of requests for a resource that can be processed simultaneously.

15. The method of claim 10 wherein the broker updates the available amount according to the amount of resources that are released to provide the guaranteed quality of service.

16. A method for a provider for managing a committed amount of resources for providing a service to a consumer, the method comprising:
registering the committed amount of resource and a description of a capability of the provider for providing the service with a broker;
releasing an amount of resource for accomplishing a service of a desired quality of service directly to a consumer in response to a confirmation certificate, the confirmation certificate being received from the consumer, after the broker has determined, after consideration of the committed amount and the description, that the provider can provide the requested quality of service.

17. The method of claim 15 wherein:
the broker has determined, after consideration of the committed amount and description, that the provider cannot provide the requested quality of service;
the broker has presented a counter-offered quality of service to the consumer; and,
the consumer has accepted the counter-offered quality of service, and confirmation certificate is representative of the counter-offered quality of service.

18. A system for negotiating service transactions between providers and consumers comprising:
a broker;
a provider in communication with the broker, the provider registering a demanded amount of a resource that is already committed to other consumers and a description of a capability of the provider for providing the service; and
a consumer in communication with the broker and with the provider, the consumer requesting a desired quality of service from the broker, the broker using the demanded amount and description to evaluate the request, the broker sending a confirmation certificate to the consumer for further transmission directly to the provider when the provider has the resources to provide the quality of service.

19. The system of claim 18 wherein the broker is in communication with a plurality of the providers, and further wherein the confirmation certificate is valid only for one provider that can provide the requested quality of service.

20. The system of claim 19 wherein the requested quality of service is concurrency, the number of requests for a resource that can be processed simultaneously.

21. The system of claim 18 wherein the requested quality of service is response time.

22. The system of claim 18 wherein the quality of service is throughput, throughput being the number of requests for a resource that can be processed per unit time.

23. A system for negotiating service transactions comprising:
a broker;
a provider means for registering a demanded amount of resources and a description of the provider capability for providing the service with the broker;
a service consumer in communication with the broker and with the provider, the consumer requesting a desired quality of service from the broker, the broker using the demanded amount of resource and service description to determine if servicing the consumer request can be accommodated, the broker sending a confirmation certificate to the consumer when the requested quality of service can be satisfied; and
the confirmation certificate forwarded directly from the consumer to the provider, to authorize the provider to release the resources to provide the requested quality of service to the consumer.
